(19) United States
(12) Patent Application Publication
(10) Pub. No.: US 2022/0095584 A1
(43) Pub. Date: Mar. 31, 2022

(54) Canine Teething Device

(71) Applicant: Alex Warren, Mesa, AZ (US)

(72) Inventor: Alex Warren, Mesa, AZ (US)

(21) Appl. No.: 17/035,998

(22) Filed: Sep. 29, 2020

(51) Int. Cl. A01K 15/02

(52) U.S. Cl. CPC A01K 15/026

(57) ABSTRACT

A canine teething device for alleviating teething pain in a puppy includes a shell, which defines an interior space and which is flexible or semiflexible. A phase change material is positioned in the shell and substantially occupies the interior space. The phase change material can be frozen in a freezer and the shell provided to a dog to be chewed upon. The phase change material absorbs heat from a mouth of the dog to provide relief of teething pain.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to teething devices and more particularly pertains to a new teething device for alleviating teething pain in a puppy.

### (2) Description of Related Art Including Information Disclosed Under 37 CFR 1.97 and 1.98

The prior art relates to teething devices. The prior art may comprise clothes and stuffed shells that can be soaked in water and frozen, non-cooling chew toys, chew toys having an embedded treat, a two-part toy into which water can be positioned and frozen, and molds for making ice blocks shaped as toys. What is lacking in the prior art is a reusable teething device comprising a phase change material encapsulated in a flexible or semiflexible shell.

### BRIEF SUMMARY OF THE INVENTION

An embodiment of the disclosure meets the needs presented above by generally comprising a shell, which defines an interior space and which is flexible or semiflexible. A phase change material is positioned in the shell and substantially occupies the interior space. The phase change material is configured to be frozen in a freezer. The shell is configured to be chewed upon by a dog, whereupon the phase change material is configured to absorb heat from a mouth of the dog to provide relief of teething pain.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a canine teething device according to an embodiment of the disclosure.

FIG. 2 is a side view of an embodiment of the disclosure.

FIG. 3 is a side cross-sectional view of an embodiment of the disclosure.

FIG. 4 is an end cross-sectional view of an embodiment of the disclosure.

FIG. 5 is an isometric perspective view of an alternative embodiment of the disclosure.

FIG. 6 is an in-use view of an embodiment of the disclosure.

### DETAILED DESCRIPTION OF THE INVENTION

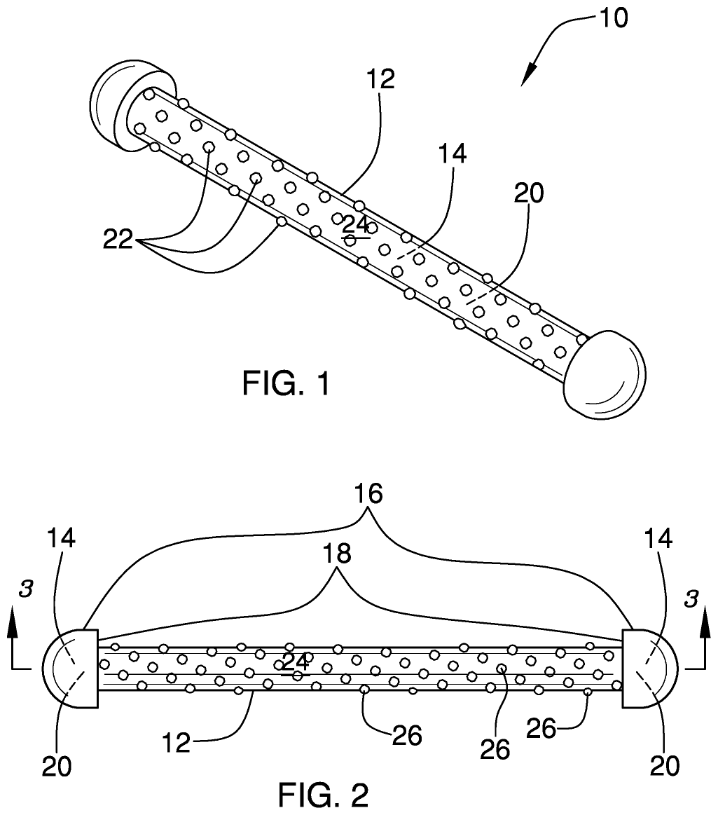

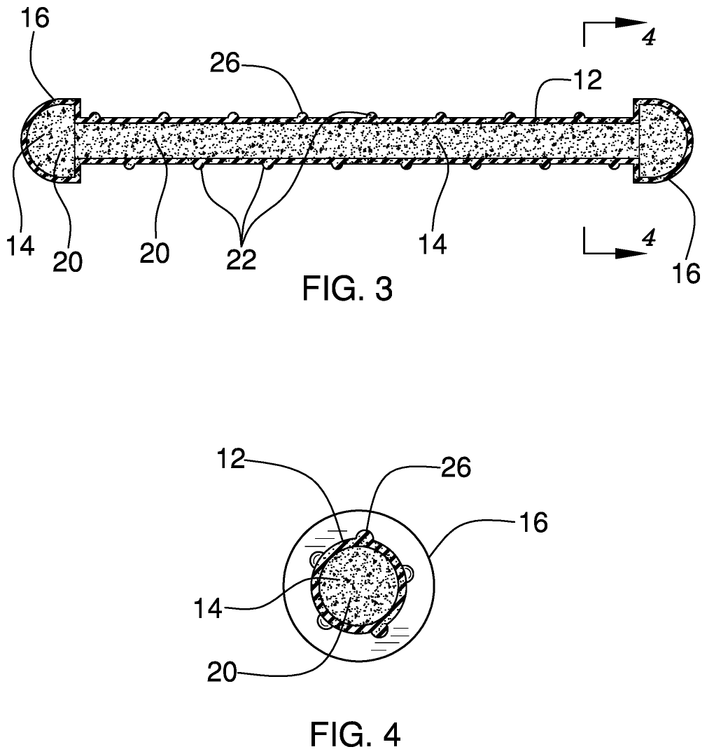

With reference now to the drawings, and in particular to FIGS. 1 through 6 thereof, a new teething device embodying the principles and concepts of an embodiment of the disclosure and generally designated by the reference numeral 10 will be described.

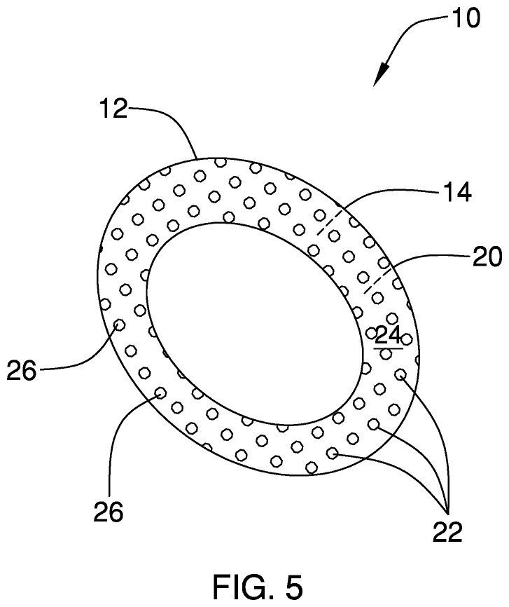

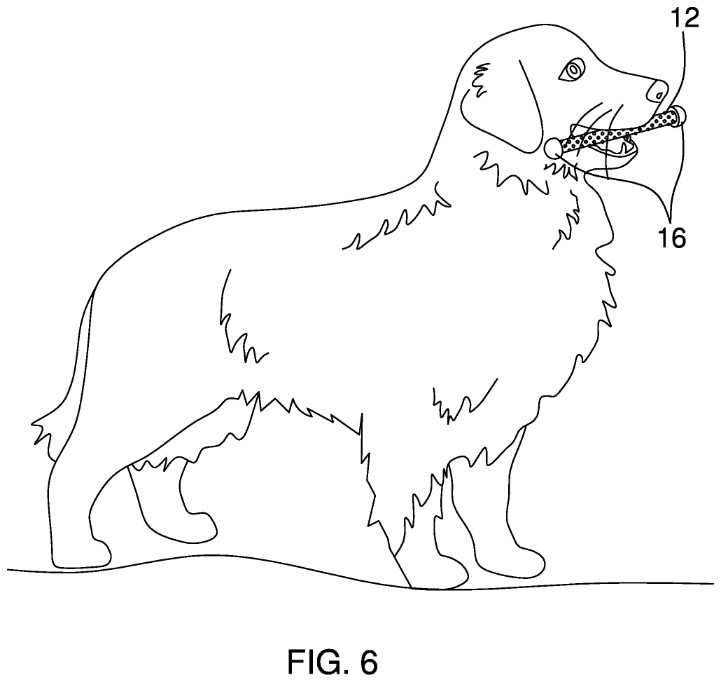

As best illustrated in FIGS. 1 through 6, the canine teething device 10 generally comprises a shell 12, which defines an interior space 14 and which is flexible or semiflexible. The shell 12 comprises plastic, silicone, or rubber, which should be interpreted to mean only plastic, only silicone, only rubber, or any combination thereof. The shell 12 may be substantially cylindrically shaped, as shown in FIGS. 1-4. The shell 12 also may be ring shaped, as shown in FIG. 5, or alternatively shaped, such as bone shaped, horseshoe shaped, and the like.

With the shell 12 being substantially cylindrically shaped, each of a pair of protuberances 16 is engaged to and extends arcuately from a respective opposed end 18 of the shell 12. The protuberance 16 is hollow so that the protuberance 16 is fluidically engaged to the shell 12. Thus, the pair of protuberances 16 and the shell 12 define the interior space 14. The protuberances 16 serve to deter swallowing of the device 10 and provide handles for a user.

A phase change material 20 is positioned in the shell 12 and substantially occupies the interior space 14. The phase change material 20 comprises at least one of water, hydroxyethyl cellulose, [2] [3] sodium polyacrylate, and vinyl-coated silica gel, which should be interpreted to mean only water, only water and hydroxyethyl cellulose, only water and [2] [3] sodium polyacrylate, only water and vinyl-coated silica gel, or any combination of water, hydroxyethyl cellulose, [2][3] sodium polyacrylate, and vinyl-coated silica gel.

The phase change material 20 is configured to be frozen in a freezer. The shell 12 is configured to be chewed upon by a dog, whereupon the phase change material 20 is configured to absorb heat from a mouth of the dog, and in particular a puppy to provide relief of teething pain. The device 10 also is anticipated to provide a means cooling for a pet on a hot day.

A plurality of protrusions 22 is engaged to and extends from an outer surface 24 of the shell 12. The protrusions 22 massage the gums of the dog while chewing the shell 12. Each protrusion 22 may comprise a nub 26, which is substantially half spherically shaped. The present invention anticipates the protrusion 22 being alternatively shaped, such as triangularly shaped, squarely shaped, ovally shaped, and the like.

In use, the shell 12 containing the phase change material 20 is positioned in a freezer and frozen. The shell 12 then can be provided to a dog to be chewed upon. The phase change material 20 absorbs heat from a mouth of the dog to provide relief of teething pain.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A canine teething device comprising:
a shell defining an interior space, the shell being flexible or semiflexible; and
a phase change material positioned in the shell and substantially occupying the interior space, wherein the phase change material is configured for being frozen in a freezer, wherein the shell is configured for being chewed upon by a dog, wherein the phase change material is configured for absorbing heat from a mouth of the dog for providing relief of teething pain.

2. The canine teething device of claim 1, wherein the shell comprises plastic, silicone, or rubber.

3. The canine teething device of claim 1, wherein the shell is substantially cylindrically shaped.

4. The canine teething device of claim 3, further including a pair of protuberances, each protuberance being engaged to and extending arcuately from a respective opposed end of the shell, the protuberance being hollow such that the protuberance is fluidically engaged to the shell, the pair of protuberances and the shell defining the interior space.

5. The canine teething device of claim 1, further including a plurality of protrusions engaged to and extending from an outer surface of the shell.

6. The canine teething device of claim 5, wherein each protrusion comprises a nub, the nub being substantially half spherically shaped.

7. The canine teething device of claim 1, wherein the phase change material comprises at least one of water, hydroxyethyl cellulose, [2] [3] sodium polyacrylate, and vinyl-coated silica gel.

8. The canine teething device of claim 1, wherein the shell is ring shaped.

9. A canine teething device comprising:
a shell defining an interior space, the shell being flexible or semiflexible, the shell comprising plastic, silicone, or rubber, the shell being substantially cylindrically shaped;
a plurality of protrusions engaged to and extending from an outer surface of the shell, each protrusion comprising a nub, the nub being substantially half spherically shaped;
a pair of protuberances, each protuberance being engaged to and extending arcuately from a respective opposed end of the shell, the protuberance being hollow such that the protuberance is fluidically engaged to the shell, the pair of protuberances and the shell defining the interior space; and
a phase change material positioned in the shell and substantially occupying the interior space, wherein the phase change material is configured for being frozen in a freezer, wherein the shell is configured for being chewed upon by a dog, wherein the phase change material is configured for absorbing heat from a mouth of the dog for providing relief of teething pain, the phase change material comprising at least one of water, hydroxyethyl cellulose, [2] [3] sodium polyacrylate, and vinyl-coated silica gel.

10. The canine teething device of claim 9, wherein the shell is ring shaped.
